(19) United States
(12) Patent Application Publication
(10) Pub. No.: US 2023/0083619 A1
(43) Pub. Date: Mar. 16, 2023

(54) METHOD AND SYSTEM OF GLOBAL POSITION PREDICTION FOR IMU MOTION CAPTURE

(71) Applicants: PAUL SCHREINER, COPENHAGEN (DK); KENNY ERLEBEN, COPENHAGEN (DK); SUNE DARKNER, COPENHAGEN (DK)

(72) Inventors: PAUL SCHREINER, COPENHAGEN (DK); KENNY ERLEBEN, COPENHAGEN (DK); SUNE DARKNER, COPENHAGEN (DK)

(21) Appl. No.: 17/892,009

(22) Filed: Aug. 19, 2022

Related U.S. Application Data
(60) Provisional application No. 63/235,125, filed on Aug. 19, 2021.

(51) Int. Cl. G01C 23/00; G06F 3/01; G01P 15/18; G01P 15/08

(52) U.S. Cl. CPC G01C 23/00; G06F 3/011; G01P 15/18; G01P 15/08

(57) ABSTRACT

A computerized method for global position prediction for inertial measurement unit (IMU) motion capture comprising: implementing a u-net architecture; obtaining and utilizing a source data from an IMU based motion capture system; implement the pre-processing of source data by: windowing the source data into a set of short sequences of time-windows, and performing a generic rotation of the windowed source data, wherein a motion captured by the IMU based motion capture system is invariant to a facing direction in a horizontal plane; pre-processing of a set of training targets using a set of transformations and adjusting for a center of mass and zeroing a root displacement at a start of each time window; implementing a post-processing by performing an inverse of the set of training targets to generate a plurality of positions estimations; and using a mean value of the plurality of positions estimations for a set of position predictions to generate the global position prediction.

### CLAIM OF PRIORITY

This application claims priority to U.S. Provisional Application No. 63/235,125, filed on 19 Aug. 2021 and titled METHOD AND SYSTEM OF GLOBAL POSITION PREDICTION FOR IMU MOTION CAPTURE. This provisional application is hereby incorporated by reference in its entirety.

### BACKGROUND

Motion capture is making a transition from the studio to the home and consumer markets with virtual reality (VR) game consoles and related hardware demanding lower cost and less cumbersome performance capture technologies. Camera based motion capture systems are now quite common and offer attractive solutions for both marker based and markerless capture solutions. However, inertial based motion capture solutions have the advantage of being truly untethered, do not suffer from occlusion problems, and avoid the need for studio space with carefully calibrated cameras. The other advantage is that inertial measurement units (IMUs) are considerably less expensive than camera-based systems. The problem with IMU-based motion capture is that it does not provide a direct measurement of position. IMUs typically include accelerometers, magnetometers, and gyroscopes, which allow for an excellent measurement of rotation that can be used to reconstruct the pose of limbs as well as the orientation of the capture subject. In contrast, it may not be currently possible to calculate useful position estimates through integration of the accelerometer signal due to noise and bias in these measurements. The standard commercial solutions apply heuristics (e.g., reconstruct from an assumed foot-ground contact) and otherwise assume that errors can be corrected by users with software in post processing. It is noted that this problem is also not unique to IMU suits, but exists for other measurement systems which focus on joint angle measurements, such as exoskeletons or strain sensors embedded in clothing.

IMU motion capture systems provide orientations of body parts with respect to a world fixed coordinate system. The data may have no notion of global placement of the character. When the character's body remains in physical contact with the world, it can find a mapping from a time series of local information to global placement. This can be done through time-integration of the kinematics and changing ground contacts. These methods can be computationally heavy, and they can deal with generic motion, but they cannot exploit knowledge about motion patterns specific to humans. Ultimately, they suffer from numerical approximation errors trough integration of the IMU sensor signal. Another approach to find this mapping is by using a data driven method such as neural networks, which are typically faster to compute and produce life like motion data due to the motion being drawn from real underlying data.

### SUMMARY OF THE INVENTION

A computerized method for global position prediction for inertial measurement unit (IMU) motion capture comprising: implementing a u-net architecture; obtaining and utilizing a source data from an IMU based motion capture system; implement the pre-processing of source data by: windowing the source data into a set of short sequences of time-windows, and performing a generic rotation of the windowed source data, wherein a motion captured by the IMU based motion capture system is invariant to a facing direction in a horizontal plane; pre-processing of a set of training targets using a set of transformations and adjusting for a center of mass and zeroing a root displacement at a start of each time window; implementing a post-processing by performing an inverse of the set of training targets to generate a plurality of positions estimations; and using a mean value of the plurality of positions estimations for a set of position predictions to generate the global position prediction.

### BRIEF DESCRIPTION OF THE DRAWINGS

The present application can be best understood by reference to the following description taken in conjunction with the accompanying figures, in which like parts may be referred to by like numerals.

FIG. 1 illustrates an example IMU-based motion capture for an unseen motion capture data, according to some embodiments.

FIG. 2 illustrates an example input data preprocessing pipeline for motion capture data, according to some embodiments.

FIG. 3 illustrates an example u-net layout, according to some embodiments.

FIG. 4 illustrates an example table showing a comparison between different methods and data, either all, or run, walk, and idle (RWI), according to some embodiments.

FIG. 5 illustrates an example validation loss plot of all experiments (e.g. absolute vertical (AV) or vertical displacement(VD), all data (ALL) or run walk idle (RWI), and different networks), according to some embodiments.

FIG. 6 illustrates an example set of probability density functions showing the distribution of the per frame error on each axis for all motion, according to some embodiments.

FIG. 7 illustrates an example estimation plot of a character jumping, according to some embodiments.

FIG. 8 illustrates an example top view of a trajectory of a character walking in a straight line, according to some embodiments.

FIG. 9 illustrates an example view of horizontal displacement and vertical position estimates for the AVALL u-net, according to some embodiments.

FIG. 10 illustrates an example IMU-based motion capture for a walk motion, according to some embodiments.

FIG. 11 illustrates an example chart showing a comparison between the absolute height estimate, and height estimated by integrating displacements, according to some embodiments.

FIG. 12 illustrates an example chart showing a comparison between a model trained using the ALL data set and a model trained using the more specialized RWI data set, according to some embodiments.

FIG. 13 an example IMU-based motion capture for a running motion with a flight phase, according to some embodiments.

FIG. 14 illustrates an example process for global position prediction for IMU motion capture, according to some embodiments.

FIG. 15 illustrates an example process for data sourcing, according to some embodiments.

FIG. 16 illustrates an example data pre-processing process, according to some embodiments.

FIG. 17 illustrates an example process for pre-processing of training targets, according to some embodiments.

FIG. 18 depicts an exemplary computing system that can be configured to perform any one of the processes provided herein.

The Figures described above are a representative set and are not an exhaustive with respect to embodying the invention.

### DESCRIPTION

Disclosed are a system, method, and article of manufacture for global position prediction for IMI motion capture. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Accelerometer is a device that measures acceleration such as proper acceleration. Proper acceleration is the acceleration (e.g. the rate of change of velocity) of a body in its own instantaneous rest frame.

Gyroscope is a device used for measuring or maintaining orientation and angular velocity.

Electromotive force/field (EMF) sensor measures the ambient (e.g. surrounding) electromagnetic field(s).

Inertial measurement unit (IMU) is an electronic device that measures and reports a body's specific force, angular rate, and sometimes the orientation of the body, using a combination of accelerometers, gyroscopes, and sometimes magnetometers.

Machine learning is a type of artificial intelligence (Al) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning.

Recurrent neural network (RNN) is a class of artificial neural networks where connections between nodes form a directed graph along a temporal sequence. This allows it to exhibit temporal dynamic behavior. Derived from feedforward neural networks, RNNs can use their internal state (memory) to process variable length sequences of inputs.

### Example System for Global Position Prediction for IMU Motion Capture

A method can be used for reconstructing a global position for IMU-based motion capture. IMU suits can provide pose data along with the global orientation of a capture subject. Additional/other methods can be used to set the global position. For example, an IMU-based motion capture method can use a large collection of motion capture data to train a universal neural network to predict vertical height and per frame horizontal displacement given a short window of pose data. This can integrate horizontal position changes along with measured root orientation to produce a global output motion. The IMU-based motion capture method can be refined in a final step with a kinematic touch up. The IMU-based motion capture method can use various network architectures and data representations along with a quantitative evaluation of the method for different classes of motion.

The IMU-based motion capture method can utilize a learning-based solution to compute the global position of IMU motion capture by exploiting a large-collection of previously recorded optical motion capture data. The IMU-based motion capture method can train a universal network (u-net) to predict the global body displacement from the optical skeleton data based on a short history of pose data. It is noted that the pose includes a lot of information about the activity being captured, and that a short temporal window of data provides sufficient information to predict the trajectory. The trained u-net model can be used to predict the vertical position of the root, and displacements per frame in the horizontal plane. The latter is integrated to reconstruct the global motion.

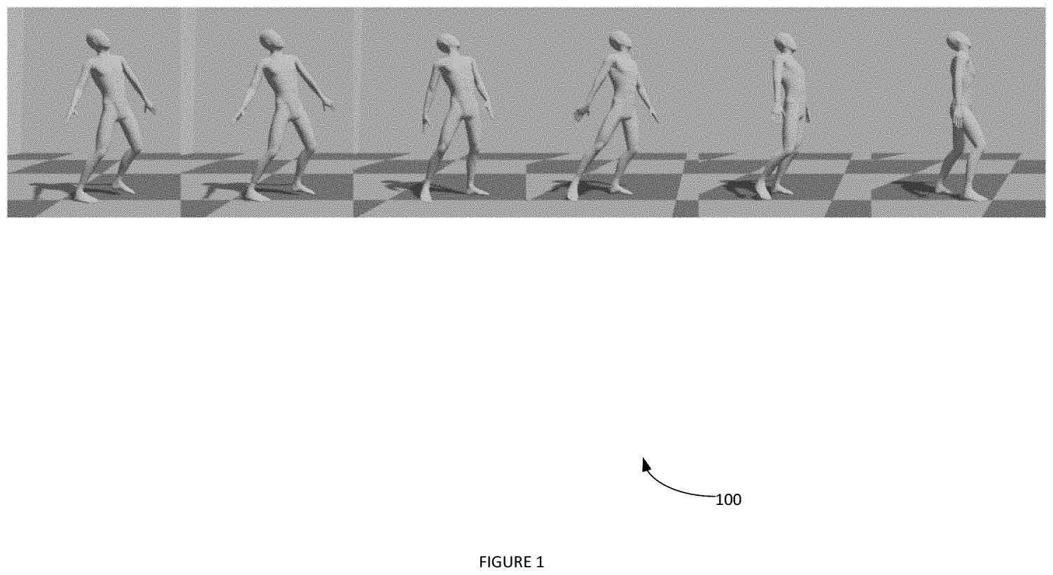

The use of a fixed temporal window makes the IMU-based motion capture method can be history independent, in contrast to, for instance, a recurrent neural network. MU-based motion capture method can reconstruct from the u-net is high quality. A kinematic touch-up can be applied to address a foot-skate motion. FIG. 1 (infra) shows a preview of the results. In addition to the qualitative evaluation of the animations, errors can be computed for reconstructions. This allows us to evaluate design decisions, such as the network architecture and choice of data representations.

FIG. 1 illustrates an example IMU-based motion capture for an unseen motion capture data, according to some embodiments. U-nets can be trained with a large corpus of motion capture data. This can be used to reconstruct global position for a wide variety of behaviors, even this unusual zombie-style walk.

It is noted that ML can be used for root positioning problem of motion-capture systems. Accordingly, an IMU-based motion-capture system can use ML in position estimation for IMU capture has not been investigated to date.

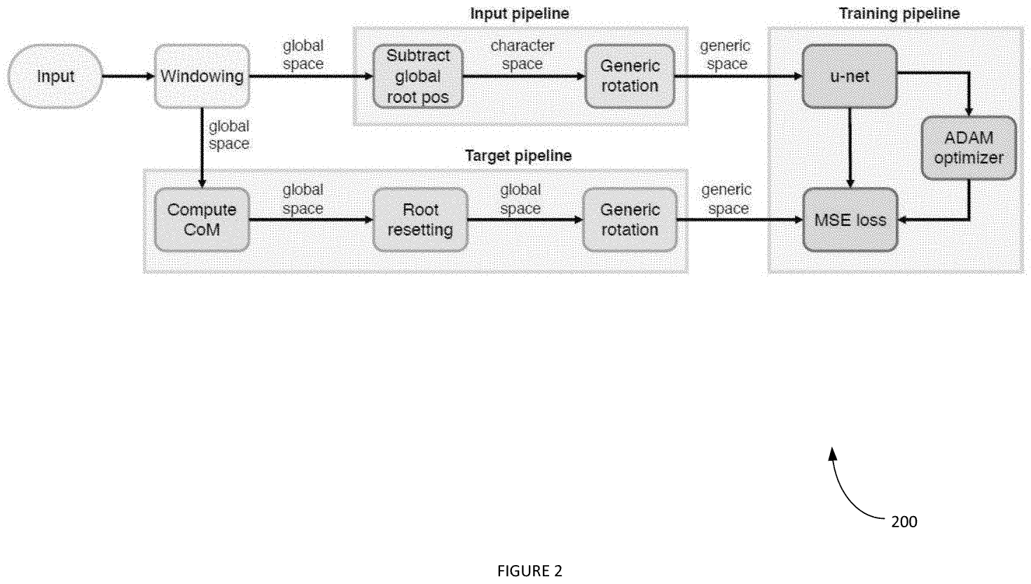

FIG. 2 illustrates an example input data preprocessing pipeline 200 for motion capture data, according to some embodiments. The input data can be imported from a motion library. The input data can be used as targets for training a neural network. The neural network can be used to predict center of mass (CoM) positions but it can be extended to other types of positions other than CoM (e.g. A, B, C, etc.) given a time-window of relative joint data input. FIG. 2 provides an overview of different parts of the training pipeline.

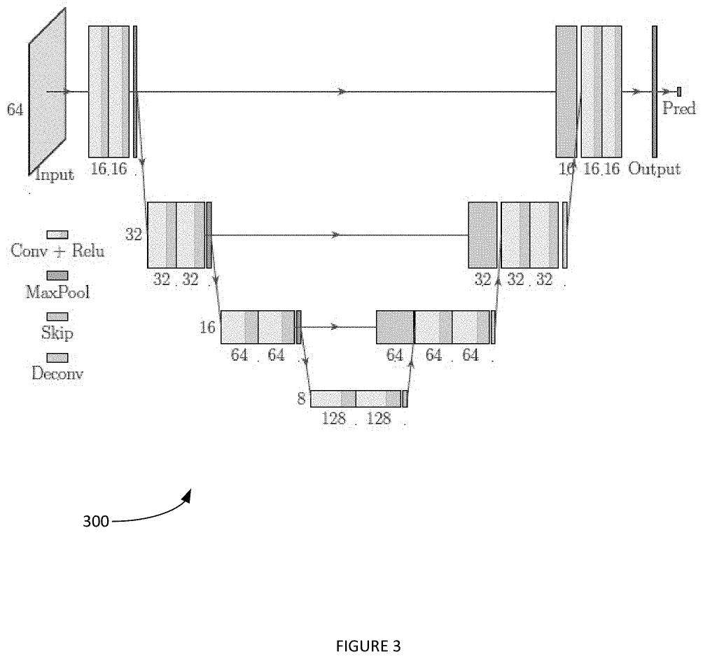

FIG. 3 illustrates an example u-net layout 300, according to some embodiments. U-net layout 300 shows that the skip connections and up/down sampling allow the u-net to handle time-series data and perform analysis of data at different frequency levels.

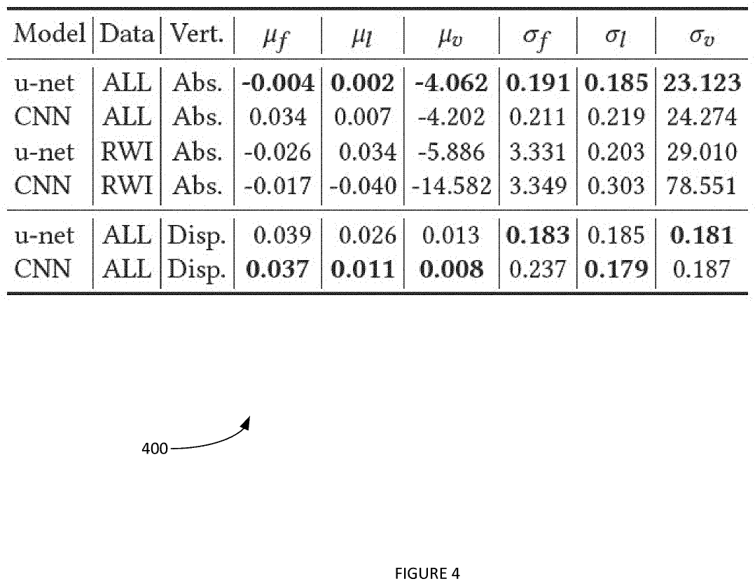

FIG. 4 illustrates an example table 400 showing a comparison between different methods and data, either all, or run, walk, and idle (RWI), according to some embodiments. The error mean μ and standard deviation a is shown for forward, lateral, and vertical directions as denoted by subscripts. All units are cm per frame except for those where the vertical output is an absolute position estimate, in which case the units are cm.

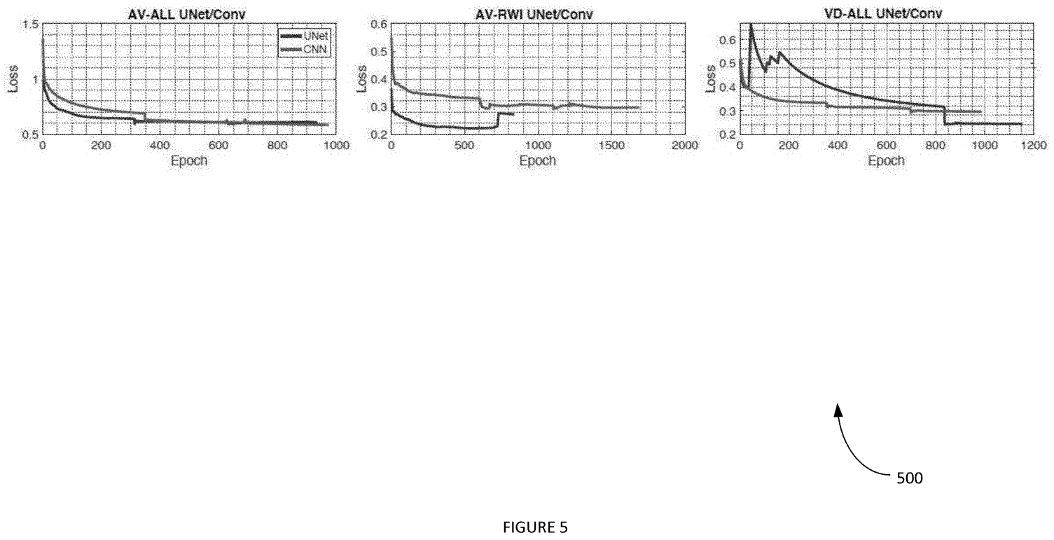

FIG. 5 illustrates an example validation loss plot 500 of all experiments (e.g. absolute vertical (AV) or vertical displacement(VD), all data (ALL) or run walk idle (RWI), and different networks), according to some embodiments. It is noted that the discontinuities in most plots caused by restarting the ADAM optimizer. The jump in the curve of the of the u-net in the middle plot can be caused by over fitting. It is noted that the blue (e.g. u-net) and red (e.g. CNN) curves are consistently in the same loss range withing experiments.

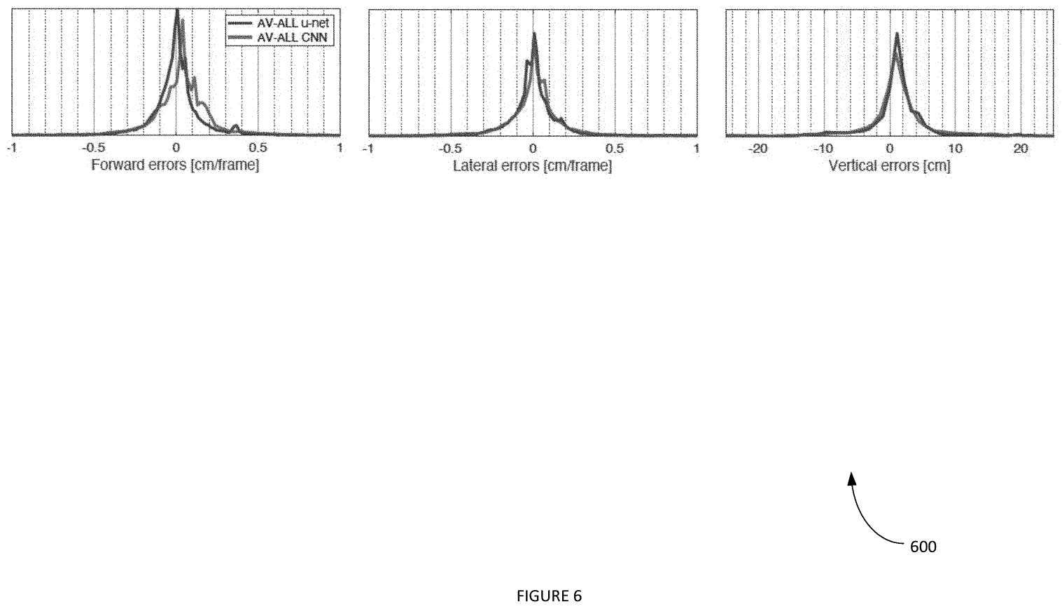

FIG. 6 illustrates an example set of probability density functions showing the distribution of the per frame error on each axis for all motion, according to some embodiments.

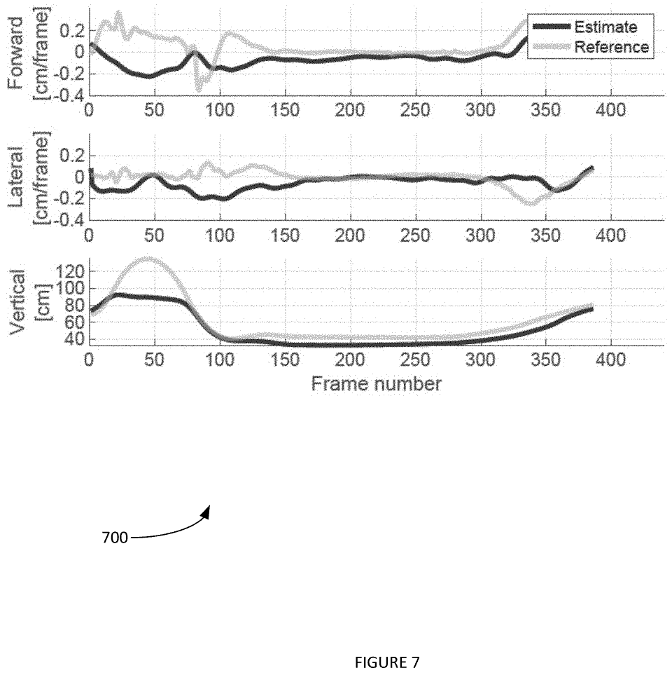

FIG. 7 illustrates an example estimation plot 700 of a character jumping, according to some embodiments. The estimation plot 700 of a character jumping can be at t=0. It is noted in one example, that the network is unable to track the height as the character lifts off but recovers as soon as the character touches down again.

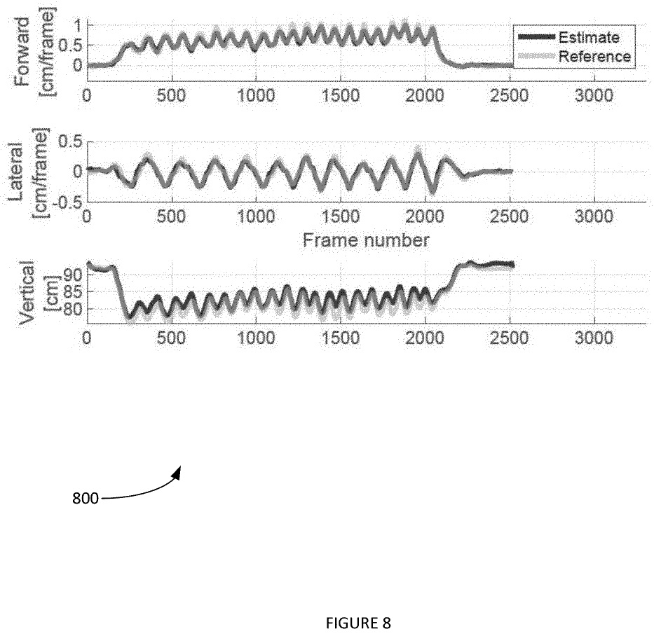

FIG. 8 illustrates an example top view 800 of a trajectory of a character walking in a straight line, according to some embodiments. View 800 illustrates how the u-net estimate is close to perfect while the CNN shows significant drift.

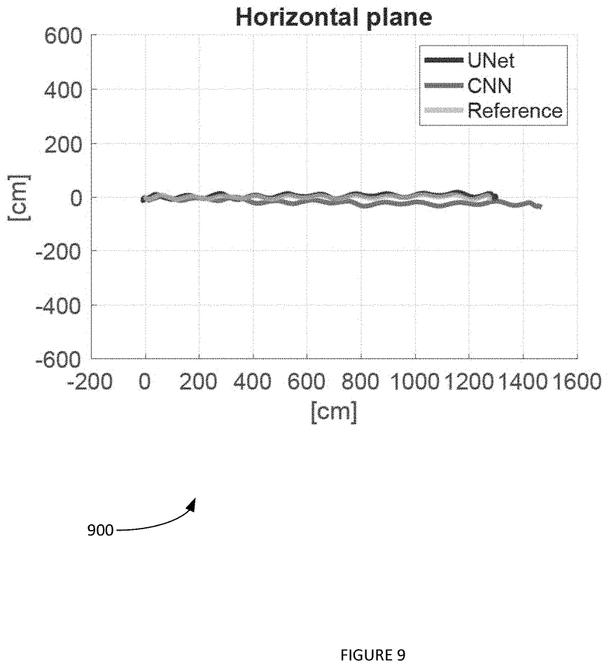

FIG. 9 illustrates an example view 900 of horizontal displacement and vertical position estimates for the AVALL u-net, according to some embodiments. View 900 shows how the network is able to estimate standstill as well as cyclic motion, acceleration, and deceleration in all axes. The constant offset on the height estimation is clearly visible.

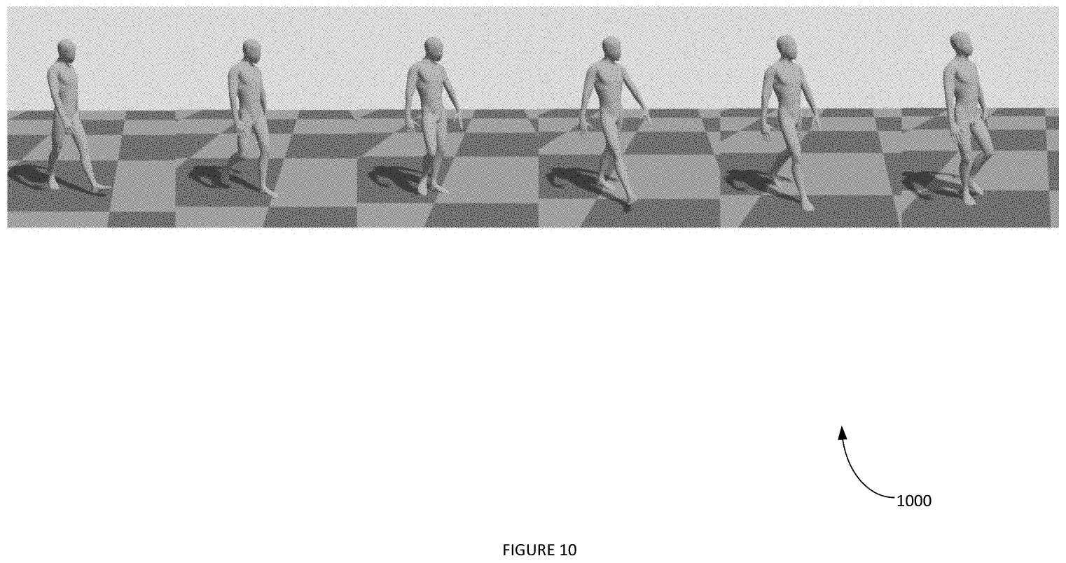

FIG. 10 illustrates an example IMU-based motion capture 1000 for a walk motion, according to some embodiments. Walk motion shows solid foot plants for the walking data that does not need any clean up as it is well represented in the database and the u-net is able to predict the motion with minimal error.

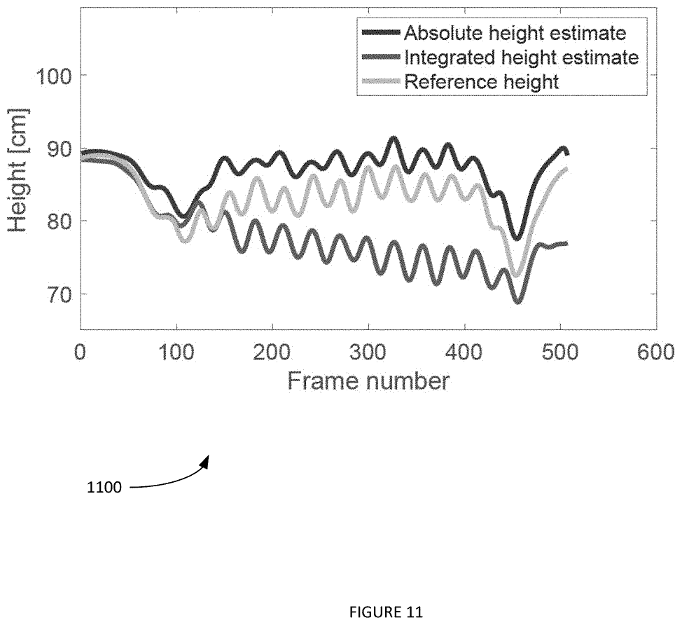

FIG. 11 illustrates an example chart 1100 showing a comparison between the absolute height estimate, and height estimated by integrating displacements, according to some embodiments. It is noted that the drift in the integrated result due to the accumulation of the error.

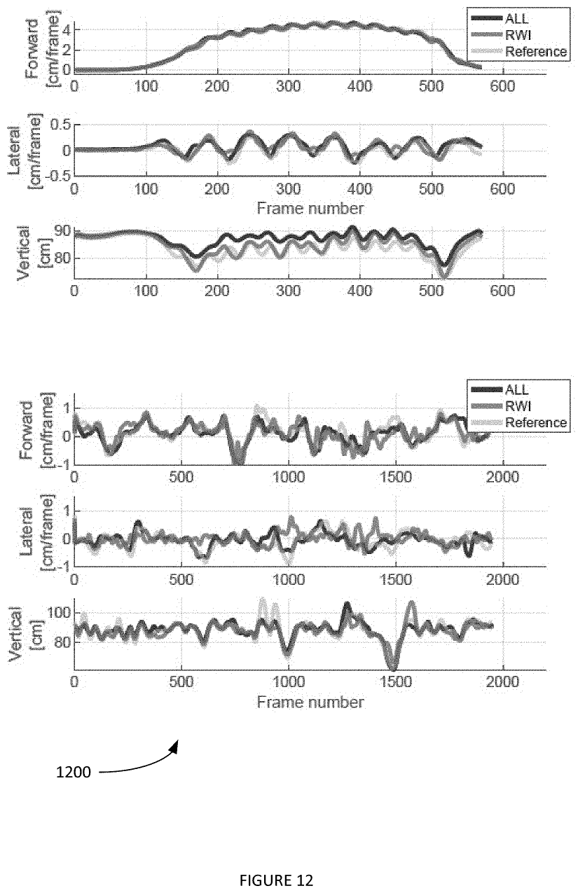

FIG. 12 illustrates an example chart 1200 showing a comparison between a model trained using the ALL data set and a model trained using the more specialized RWI data set, according to some embodiments. The top plot shows a character running, and there is a larger error in the estimation of the ALL-trained model. The bottom plot shows a character dancing, a motion type not available in the RWI data set. Chart 1200 illustrates how the RWI trained model has more difficulty predicting the motion, for example, in the lateral motion around frame 1000.

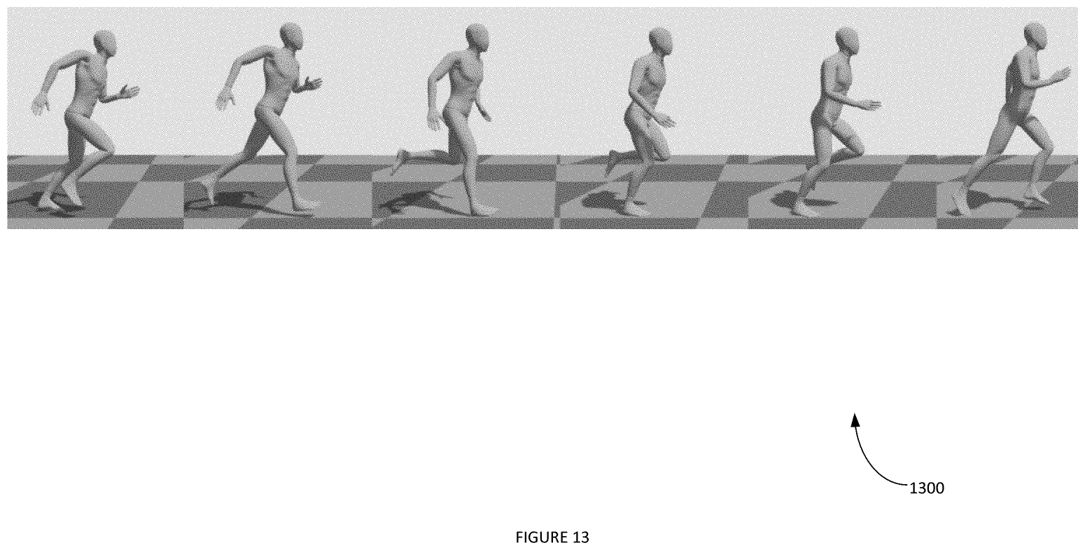

FIG. 13 an example IMU-based motion capture 1300 for a running motion with a flight phase, according to some embodiments. As shown, the running motion with a flight phase is particularly difficult for heuristic-based solutions. As shown, there is an estimated good lateral motion, as exhibited by the lack of foot skate, and predicts the vertical trajectory that is nearly imperceptible from ground truth.

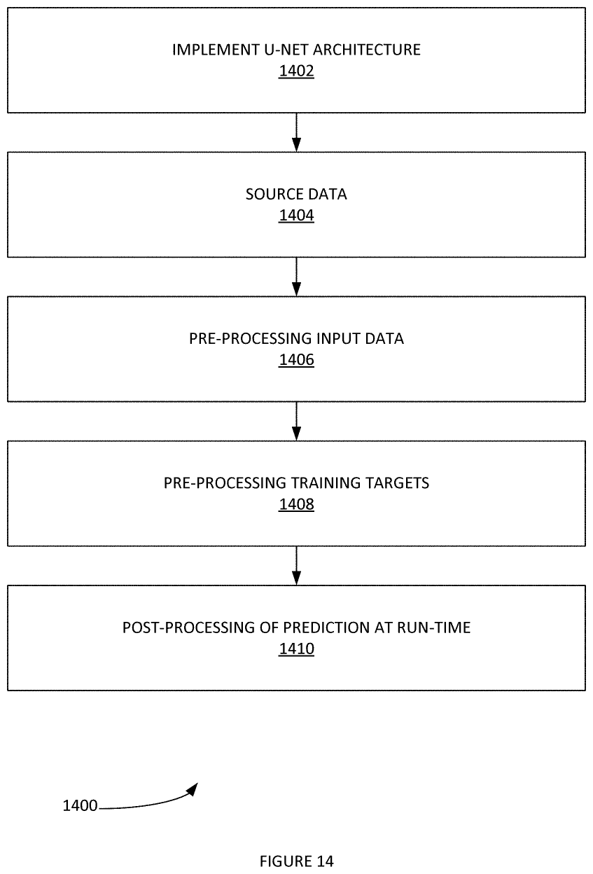

FIG. 14 illustrates an example process 1400 for global position prediction for IMU motion capture, according to some embodiments. Process 1400 can be used to implement the methods and systems provided in FIGS. 1-13. Process 1400 can be a method in character animation using the u-net architecture for regression. Process 1400 can be utilized as an alternative to recurrent neural networks adapted for classification of time series data. Process 1400 can use networks that have the advantage of being able to produce results superior to recurrent neural networks, and are generally much easier to train. Process 1400 can learn correlations between pose data and its spatial-temporal correlation structure. Process 1400 can learn these correlations at multiple temporal scales.

In step 1402, the u-net architecture can be implemented. The u-net can be modified for regression and acts as an ensemble of regression models from which process 1400 can construct a prediction. The network includes of an encoder stage and a decoder stage with skip-connections relaying information at different temporal scales.

In the encoder stage, the input data is encoded in the temporal dimension while being expanded in the feature dimension using convolutional layers. The input to the network is a 2D Tensor, with time in the vertical dimension and features in the horizontal dimension. Process 1400 can use T to denote the time-window size and N for the dimension of the combined feature vectors. In the case of a time-window of 64 frames and a character with, for example, nineteen (19) positional joint vectors, this results in a T×N=64×57 input tensor to the network.

It is noted that u-net layout is summarized in FIG. 3 supra. U-net layout 300 includes various layers, sizes, and features of a network architecture. The u-net operates at three (3) different scales in the encoding and three (3) scales in the decoding. At each scale two (2) consecutive convolutions of the input to that scale are performed. The first convolution is two (2) dimensional with a kernel spanning the entire feature dimension N. In the temporal dimension, process 1400 can use kernels of size 3 and 5 and found that a kernel of size five (5) generally provides the best results. With an input of [Batch×Channels in×T×N] the output of the first convolution looks like [Batch×Channels out×T×1]. Channel in can be 1 in some examples. The number of output channels of the first convolution doubles for each up-sampling layer and is halved for each down sampling layer.

The second convolution can be in the temporal dimension, over all the output channels from the first convolution. The activation functions used throughout the network are rectified linear units (ReLU). After each set of convolutions the output of that step is reshaped so that the input to the next layer is again of the form [Batch×1×T×F]. Here F=Channels out can be seen as a new abstract feature dimension. At the end of the layer the current output is stored for later use in the skip connections. Then the output is down sampled in the temporal dimension using a maxpool operation with a length of 2. The feature dimension can be kept constant during this step.

Between each down and up sampling layer of the same temporal scale, there can be a skip connection which passes the output of the encoder directly to its temporal counter part in the decoder side of the network. This ensures that the network can extract information and process it in the output for multiple timescales. The decoder structure can follow an inverse description of the encoding process, where the up sampling is performed using linear interpolation.

In step 1404, process 1400 can obtain and utilize source data. The raw data is from the a specified motion library and comes in the form of assets, each containing a single character doing a motion or a short sequence of motions, such as a short walk, a dance, or a jump. The motion library can include a database for humanoid motion capture data, with over 3000 different assets. To ensure uniformity throughout the data set, the selected assets can have an identical subset of the skeleton configuration. The final data set contained 577 motion assets, totaling 629,093 frames or nearly two (2) hours of motion data. The data in the motion library comes from different motion capture studios and individuals, guaranteeing diversity of the characters with respect to size, shape, and gender.

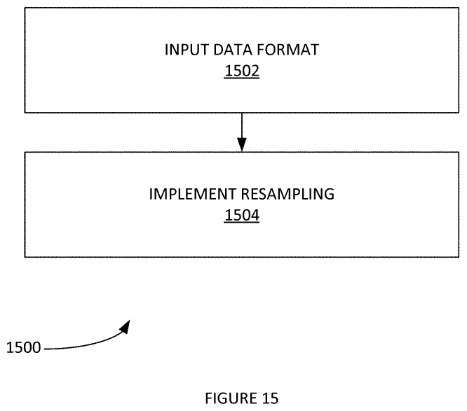

FIG. 15 illustrates an example process 1500 for data sourcing, according to some embodiments. In step 1502, process 1500 can implement input data steps. IMU based motion capture systems typically provide pose information oriented with respect to a world fixed coordinate system. Therefore, the input data can consist of position vectors that indicate a joint's position with respect to a root joint that has a fixed position in the origin of the world frame but is free to rotate.

In step 1504, process 1500 can perform resampling. The input to a u-net should have the same temporal frequency, that is, each time-window can be the same size and span the same period. However, the motion library assets come in different frame rates. Therefore in a first step, the data is re-sampled to a uniform frame rate of 100 Hz as this is consistent with typical IMU motion capture.

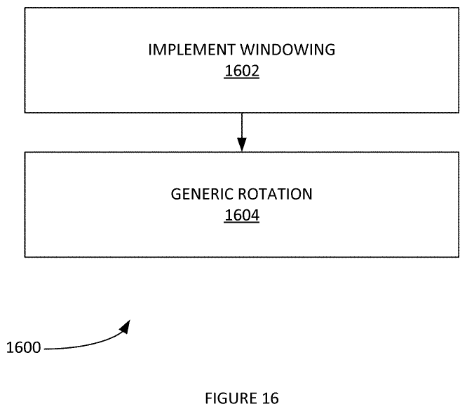

Returning to process 1400, in step 1406, process 1400 can implement the pre-processing of input data. FIG. 16 illustrates an example data pre-processing process 1600, according to some embodiments. The main steps in pre-processing data for training are extracting short temporal windows, and mapping data into a generic forward facing reference frame (see also the pipeline diagram in FIG. 2 supra). In step 1602, process 1600 can perform windowing. The data is passed to the network in short sequences of frames termed as time-windows. A time-window can be conceptually a short animation on its own, with a length of 0.64 seconds. This windowing is performed online at training time, and has the advantage that process 1600 may not need to store duplicate frame data, hence reducing memory usage during training. This may little to no impact on training time as it is simply an array of pointers to memory. The effect of the windowing can be that every frame in the data is passed to the network in T consecutive time-windows. During training, the time-windows are shuffled in order to avoid bias from temporal correlation.

In step 1604, process 1600 performs generic rotation. The motion within the physical world around us is invariant to the facing direction in the horizontal plane: whether a person walks north or south does not change the physical properties of motion. To this end, process 1600 can define a generic space in which the model is trained. In this way, when the model, when it receives a time-window, sees it in the same way. Process 1600 can define the vertical axis of the reference frame to match the global frame vertical, with both set to be opposite the direction of gravity. The axes of the horizontal plane of the reference frame is set from the orientation of the hip at the first frame of a temporal window. The hip's frontal axis is projected to the global horizontal plane to define a forward direction. The lateral motion axis in the global horizontal plane is orthogonal to both the forward and vertical axes.

Returning to process 1400, in step 1408, process 1400 performs pre-processing of training targets. To compute the training targets, process 1400 can use a slightly different set of transformations, specifically, adjusting for the center of mass and zeroing the root displacement at the start of the temporal window (as also shown in FIG. 2 supra).

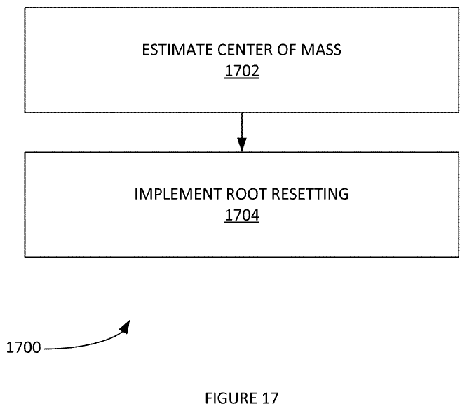

FIG. 17 illustrates an example process 1700 for pre-processing of training targets, according to some embodiments. In step 1702, process 1700 can estimate the center of mass. The root motion of the character is defined as the hip motion, which is subject to many oscillations. For example when one walks the hips wiggle left and right while the primary motion is in the forward direction. Hence, instead of using hip motion process 1700 can use an estimate of center of mass (CoM) positions. This is less oscillatory since it is a weighted average of the motion of all body parts and therefore acts as a type of low pass filter. The estimates of the center of mass are computed by summing a weighted approximation of each limb's center of mass. The weighting of each limb was performed using a re-targeting of a specified set of parameters.

In step 1704, process 1700 can implement root resetting. Process 1700 can make the network invariant to the starting position of a time-window. To achieve this, in one example, the trajectory in the horizontal plane of each time-window is reset to start at the origin. The result is that the training target is a time series representing the displacement of the character over the time-window. In step 1408, process 1400 can implement pre-processing training targets.

In step 1410, process 1400 can implement post-processing of prediction at run-time. To recover global root data, the post-processing pipeline performs the inverse of the target pre-processing. It is noted that the same frame can be present in 64 time-windows due to the windowing. This means that the network can give 64 different predictions for the CoM target of the same frame. So as a last step of the post-processing, process 1400 can choose to collect all the estimations into a final answer. Process 1400 can use the mean value for a set of position predictions.

It is noted that process 1400 can be used for estimating global placement. Using IMU data to the training can improve the performance for this type of data dramatically.

### Additional Example Computer Architecture and Systems

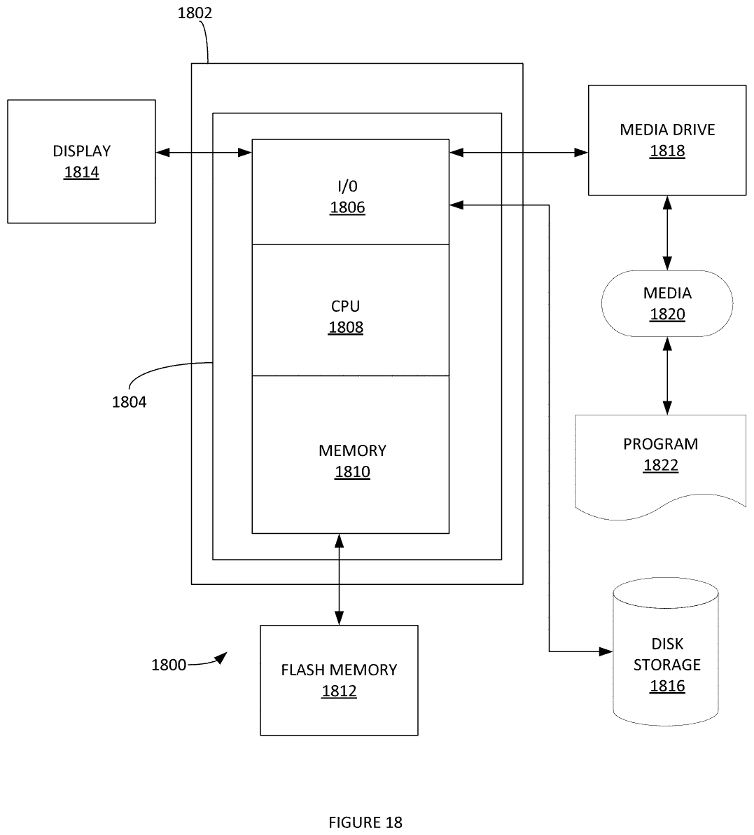

FIG. 18 depicts an exemplary computing system 1800 that can be configured to perform any one of the processes provided herein. In this context, computing system 1800 may include, for example, a processor, memory, storage, and I/O devices (e.g., monitor, keyboard, disk drive, Internet connection, etc.). However, computing system 1800 may include circuitry or other specialized hardware for carrying out some or all aspects of the processes. In some operational settings, computing system 1800 may be configured as a system that includes one or more units, each of which is configured to carry out some aspects of the processes either in software, hardware, or some combination thereof.

FIG. 18 depicts computing system 1800 with a number of components that may be used to perform any of the processes described herein. The main system 1802 includes a motherboard 1804 having an I/O section 1806, one or more central processing units (CPU) 1808, and a memory section 1810, which may have a flash memory card 1812 related to it. The I/O section 1806 can be connected to a display 1814, a keyboard and/or other user input (not shown), a disk storage unit 1816, and a media drive unit 1818. The media drive unit 1818 can read/write a computer-readable medium 1820, which can contain programs 1822 and/or data. Computing system 1800 can include a web browser. Moreover, it is noted that computing system 1800 can be configured to include additional systems in order to fulfill various functionalities. Computing system 1800 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### Conclusion

Although the present embodiments have been described with reference to specific example embodiments, various modifications and changes can be made to these embodiments without departing from the broader spirit and scope of the various embodiments.

In addition, it will be appreciated that the various operations, processes, and methods disclosed herein can be performed in any order (e.g., including using means for achieving the various operations). Accordingly, the specification and drawings are to be regarded in an illustrative rather than a restrictive sense.

1. A computerized method for global position prediction for inertial measurement unit (IMU) motion capture comprising:
implementing a u-net architecture;
obtaining and utilizing a source data from an IMU based motion capture system;
implement the pre-processing of source data by:
windowing the source data into a set of short sequences of time-windows, and
performing a generic rotation of the windowed source data, wherein a motion captured by the IMU based motion capture system is invariant to a facing direction in a horizontal plane;
pre-processing of a set of training targets using a set of transformations and adjusting for a center of mass and zeroing a root displacement at a start of each time window;
implementing a post-processing by performing an inverse of the set of training targets to generate a plurality of positions estimations; and
using a mean value of the plurality of positions estimations for a set of position predictions to generate the global position prediction.

2. The computerized method of claim 1, wherein the u-net architecture is modified for regression and acts as an ensemble of regression models used to construct a prediction.

3. The computerized method of claim 2, wherein the u-net architecture comprises an encoder stage and a decoder stage with a set of skip-connections relaying information at different temporal scales.

4. The computerized method of claim 3, wherein in the encoder stage, the input data is encoded in a temporal dimension while being expanded in a feature dimension using convolutional layers.

5. The computerized method of claim 4, wherein input to the u-net architecture is a two-dimensional (2D) Tensor, with time in the vertical dimension and features in the horizontal dimension.

6. The computerized method of claim 5, wherein between each down and up sampling layer of a same temporal scale, there is a skip connection which passes the output of the encoder directly to a temporal counter part in the decoder side.

7. The computerized method of claim 6, wherein the decoder structure follows an inverse description of the encoding process, and wherein the up sampling is performed using linear interpolation.

8. The computerized method of claim 7, wherein the IMU based motion capture system provides a pose information oriented with respect to a world fixed coordinate system.

9. The computerized system of claim 8, wherein the source data provided by the IMU based motion capture system comprises a set of position vectors that indicate a human joint's position with respect to a root joint that has a fixed position in an origin of a world frame but is free to rotate.
